(19) United States
(12) Patent Application Publication
(10) Pub. No.: US 2009/0300200 A1
(43) Pub. Date: Dec. 3, 2009

(54) Content managing module and apparatus comprising such content managing module as well as method for controlling interactive applications

(76) Inventors: Robert Jochemsen, Eindhoven (DE); Harald Woerkom, Eindhoven (NL); Bernardus Vlimmeren, Veldhoven (NL); Marcus Verhoeven, Deurne (NL); Clara Otero, Eindhoven (NL); Dietwig Lowet, Eindhoven (NL); Huibert Eggenhuisen, Waalre (NL); Peter Lenoir, 'S Hertogenbosch (NL)

Correspondence Address: NXP, B.V.;NXP INTELLECTUAL PROPERTY & LICENSING, M/S41-SJ, 1109 MCKAY DRIVE, SAN JOSE, CA, 95131, US

(21) Appl. No.: 11/631,215

(22) PCT Filed: Jun. 27, 2005
(86) PCT No.: PCT/IB05/52116

§ 371 Date: Jun. 4, 2009

(30) Foreign Application Priority Data
Jun. 30, 2004 (EP) 04103083.4

(51) Int. Cl. G06F 15/16

(52) U.S. Cl. 709/231

(57) ABSTRACT

In order to provide a content managing module (100, 102) as well as a method for controlling interactive applications, wherein a first data stream (D1) comprising at least one first interactive application with first interactive content is received, the first data stream (D1) being transmitted on at least one first channel, wherein it is possible to prevent a lack of interactive content stream when a consumer or user changes channel (and somewhat later changes back) while watching interactive content, it is proposed to keep receiving the first interactive content when switching (s) from the first channel to at least one second channel on which a second data stream (D2), in particular comprising at least one second interactive application with second interactive content, is transmitted.

The present invention relates to a content managing module, in particular D[igital]S[torage]M[edia]/C[ommand]C[ontrol] carousel, for managing the respective interactive content of at least one interactive application, wherein a first data stream comprising the first interactive application with the first interactive content is received, the first data stream being transmitted on at least one first channel.

The present invention further relates to an apparatus for controlling interactive applications according to the preamble of claim 3.

The present invention further relates to a method for controlling interactive applications, wherein a first data stream comprising at least one first interactive application with first interactive content is received, the first data stream being transmitted on at least one first channel.

In digital T[ele]V[ision], interactive content is sent along with the video data. The consumer or user is typically notified that such content is available, and can enable this content using the remote control. It occurs that the consumer or user changes channel while watching interactive content, and changes back somewhat later; one such case is a commercial during a game show.

After switching to the interactive channel, it takes some time (up to seconds) before the interactivity can be shown again because the system has to wait for the most up-to-date data. With other words, when the consumer or user changes channel while watching interactive content, and changes back somewhat later, it takes some time before the interactive content can be shown again.

A method for fast digital channel changing is disclosed in prior art document EP 1 117 254 A2 as well as in prior art document EP 1 389 874 A2. However, both prior art documents do not deal with interactive content.

Different problems concerning interactive content in the context of switching digital T[ele]V[ision] channels are discussed in prior art document WO 03/021958 A1 and in prior art document WO 03/025746 A1:

The prior art document WO 03/021958 A1 proposes a solution to ensure that when a channel switch occurs, the interactive application of the previous channel is dosed timely and correctly. It does not provide any solution to reduce the time an interactive application needs to be up and running again when the consumer or user switches back to the previous channel.

The prior art document WO 03/025746 A1 provides techniques to keep an interactive application running even if the consumer or user switches to another channel. In order to accomplish this, a combination of different techniques is proposed:

making the interactivity application robust, so the interactivity application does not crash when files are missing; it should be noted that this solution assumes that the interactivity data of the previous channel is not received any more;

caching the interactivity content of a channel such that when a channel switch occurs, this cached data can be used in the assumption that it does not become outdated;

trying to use the interactivity content of the new channel for the application; obviously, this can only be done if both channels contain a similar file system.

Neither prior art document WO 03/021958 A1 nor prior art document WO 03/025746 A1 deals with or even solves the problem how to ensure that the interactive application of the previous channel is up and running as quick as possible when the consumer or user returns to the previous channel.

Starting from the disadvantages and shortcomings as described above and taking the prior art as discussed into account, an object of the present invention is to prevent a lack of interactive content stream when a consumer or user changes channel (and somewhat later changes back) while watching interactive content.

The object of the present invention is achieved by a content managing module comprising the features of claim 1, by an apparatus comprising the features of claim 3 as well as by a method comprising the features of claim 7. Advantageous embodiments and expedient improvements of the present invention are disclosed in the respective dependent claims.

The present invention is principally based on the idea to keep receiving the interactivity data, in particular the data carousel, of the previous channel, if necessary by using a second decoding path. Thus, the object of the present invention is solved when the apparatus, in particular the content managing system (content managing module) of the present invention keeps on receiving the interactivity information, especially in the background. Therefore, it is proposed to keep receiving the interactive content of the last channel for which the interactivity was enabled, in particular by the consumer or user.

In contrast to the present invention where the old channel can still be monitored even if the second data stream does not contain an interactive application, the prior art system breaks the connection with the old channel when a consumer or user changes channel, even if the new channel does not contain interactive data.

In a preferred embodiment of the present invention, the interactive application can be kept running (preferably in the background) as well as be closed when switching to another channel. However, in either case the receiving of the interactivity data of the previous channel is kept. This leads to the advantage that the time needed for the interactivity application of the previous channel to be up and running can be significantly reduced.

Contrary to above-discussed prior art document WO 03/025746 A1, it is not proposed according to the present invention to cache the old data but to cache the currently broadcasted interactivity data.

Advantageously, an embodiment of the present invention keeps on receiving and optionally reacting to the interactivity information in the background. Thus, the interactivity information is up-to-date at the moment channels are switched. For this purpose, an embodiment of the present invention keeps receiving the interactive content of the last channel for which the interactivity was enabled, for example by the consumer or user.

A preferred embodiment of the present invention comprises an auxiliary reception path, for example a tuner, a demodulator, optionally a decryption module, and a demultiplexing unit. Interactivity data is optionally handled by a virtual machine, such as a Java V[irtual]M[achine]. By keeping the virtual machine active and feeding it with the incoming data in the background, its status will be up-to-date when the consumer or user switches back to the interactive channel.

In general the present invention relates to enabling fast zapping of interactive content in digital T[ele]V[ision], in particular by receiving interactivity data in the background. In accordance therewith, the present invention finally relates to the use of at least one content managing module as described above and/or of at least one apparatus as described above and/or of the method as described above in a multimedia presentation standard, such as D[igital]V[ideo]B[roadcasting], M[ultimedia]H[ome]P[latform], M[ultimedia and]H[ypermedia]E[xperts]G[roup] and/or O[pen]C[able]A[pplication]P[latform].

Independently thereof or in combination therewith, displaying the interactive information for the last interactively watched channel can be immediately started (without waiting for confirmation of the consumer or user; such confirmation is neither necessary nor provided). To this aim, advantageously the interactive content is started immediately in general for all channels or more specifically for programs for which the interactive content was enabled, for example by the consumer or user previously. Consequently, the content is available immediately.

Preferably, the method for monitoring the previous channel can also be used to monitor other channels, for example the consumer's or user's favourite channel. By this way, these other channels will also benefit from the same speed boost.

In other words, the present system as well as the present method are not restricted to monitoring just one channel but can also be used to monitor more, for instance several channels. The number of channels monitored can vary dynamically based on parameters such as the size of the interactive content and/or the consumer's or user's zapping behaviour.

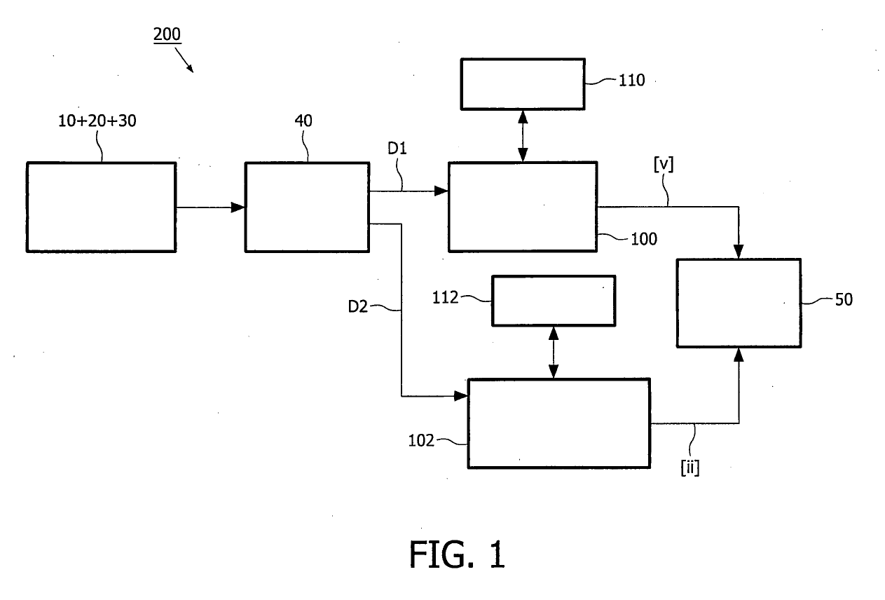

As already discussed above, there are several options to embody as well as to improve the teaching of the present invention in an advantageous manner. To this aim, reference is made to the claims respectively dependent on claim 1, on claim 3 and on claim 7; further improvements, features and advantages of the present invention are explained below in more detail with reference to two preferred embodiments by way of example and to the accompanying drawings (cf. FIG. 1 to FIG. 3B) where

FIG. 1 schematically shows a first embodiment of an apparatus according to the present invention comprising a content managing module according to the present invention and working according to the method of the present invention;

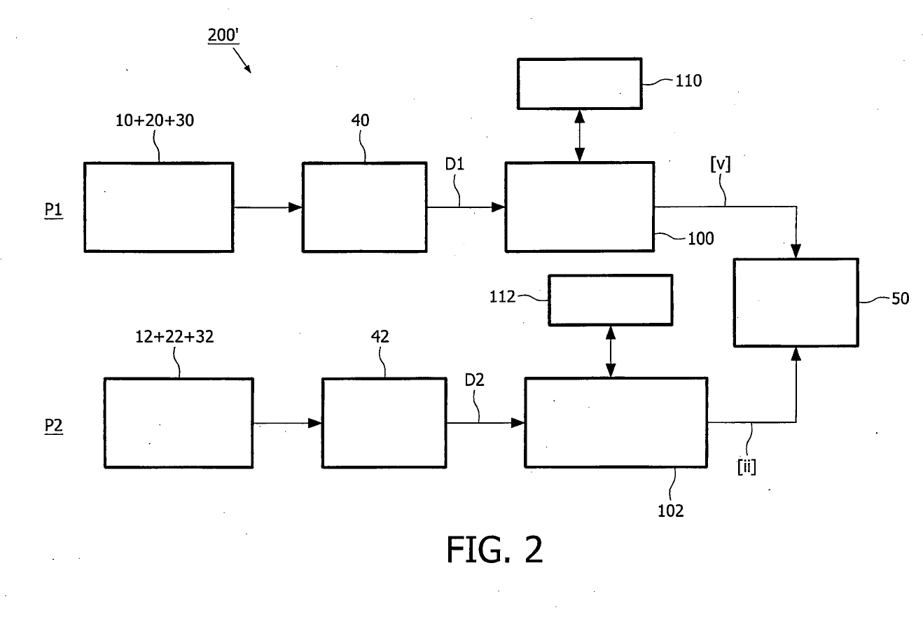

FIG. 2 schematically shows a second embodiment of an apparatus according to the present invention comprising content managing modules according to the present invention and working according to the method of the present invention;

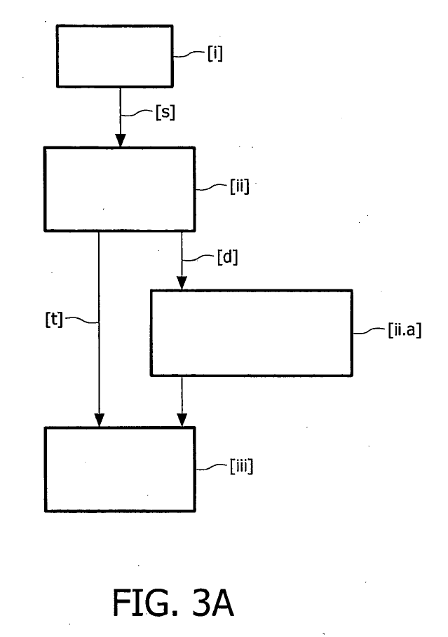

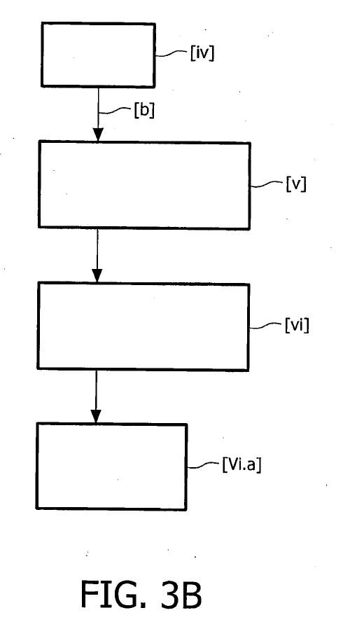

FIG. 3A schematically shows the first part of a flow-chart of the method according to the present invention when the consumer or user changes the channel; and

FIG. 3B schematically shows the second part of a flow-chart of the method according to the present invention when the consumer or user changes back to the previous channel.

The same reference numerals are used for corresponding parts in FIG. 1 to FIG. 3B.

In order to avoid unnecessary repetitions, the following description regarding the embodiments, characteristics and advantages of the present invention relates (unless stated otherwise)

to the first embodiment of the apparatus 200 according to the present invention (cf. FIG. 1) as well as

to the second embodiment of the apparatus 200′ according to the present invention (cf. FIG. 2),

both embodiments 200, 200′ being operated according to the method of the present invention (cf. FIGS. 3A and 3B).

A “normal” reception path according to the state of the art comprises:

a tuner module or receiver module,

a demodulator module,

optionally a decryption module,

a demultiplexing unit,

a content managing module,

a content playing module and

optionally a cache (memory); according to the prior art, the cache is optional, but desirable.

According to the present invention, the cache 110 is essential. The content managing system 100, for example a D[igital]S[torage]M[edia]/C[ommand]C[ontrol] carousel, is the main focus of the present invention. The content playing system 50 may be a Java V[irtual]M[achine] (in the exemplary case of M[ultimedia]H[ome]P[latform]) but may also be any other content playing system (in the exemplary case of M[ultimedia and]H[ypermedia]E[xperts]G[roup]).

In the following, the first example of the apparatus 200 according to the present invention is depicted in FIG. 1. This implementation of the present invention is useful if the consumer or user zaps to a channel that is on the same transport stream as the monitored channel (=reference numeral t in FIG. 3A).

The apparatus 200 is designed for controlling interactive applications and comprises

a tuner unit 10 for receiving a first data stream DI and a second data stream. D2,

a demodulator unit 20 for demodulating the received data streams D1, D2, and

optionally a decryption module 30 for decrypting the received data streams D1, D2 for the case that a broadcaster has decided to encrypt the interactive content of the data streams D1, D2.

Furthermore, for demultiplexing the first interactive content contained in the first data stream D1 as well as the second interactive content contained in the second data stream D2, the apparatus 200 comprises a demultiplexing unit (or demultiplexer) 40.

For managing the respective interactive content of the respective interactive application, a content managing module (=D[igital]S[torage]M[edia]/C[ommand]C[ontrol] carousel system 100) is connected between the demultiplexing unit 40 and a content playing module, namely a Java V[irtual]M[achine] 50 for playing the first interactive content and the second interactive content.

Moreover, the content managing module 100 is connected to a cache unit 110 for keeping and/or saving the first interactive content during the time of reception of the second interactive content.

Contrary to the prior art, the apparatus 200 comprises a second content managing module 102, to which a second cache unit 112 is connected. The apparatus 200 comprises at least one integrated circuit being part of at least one digital T[ele]V[ision] receiver.

In FIG. 2, an apparatus 200′ is depicted which is used if the consumer or user zaps to a second channel which is on a different transport stream as the monitored channel (=reference numeral d in FIG. 3A). The apparatus 200′ comprises the components as described with respect to FIG. 1; additionally, the apparatus 200′ comprises

a second tuner 12,

a second demodulator 22 and

optionally a second decryption module 32.

With respect to this second decryption module 32, it has to be taken into consideration that decryption modules are not easy to replicate (whereas an extra tuner 12 and an extra demodulator 22 is easy to replicate); the specifics depend on the actual decryption system. In this context, it has to be seen that it depends on the respective broadcaster whether a decryption module 30, 32 is required or not. The broadcaster can decide not to encrypt the interactive content of a stream, even though the video is encrypted.

Moreover, the apparatus 200′ comprises a second demultiplexing unit (or demultiplexer) 42, which is connected between the decryption module 32 and the second content management module (=D[igital]S[torage]M[edia]/C[ommand]C[ontrol] carousel 102 for the monitored channel).

In the case of the first embodiment 200 according to FIG. 1 as well as in the case of the second embodiment 200′ according to FIG. 2, the content management system 100 keeps monitoring the old (=first) channel and keeps the content up-to-date. At the moment, the consumer or user zaps back to the old (=first) channel, the content is available and up to date for which reason the content playing system 50 can play the content immediately.

Generally, the tuner 10, 12, the demodulator 20, 22, the decryption module 30, 32 and the demultiplexer 40, 42 can for instance be embodied as hardware (though the demultiplexer 40, 42 may for instance also be implemented at least partially in software).

According to the present invention, multiple channels can be monitored in the described way, for instance the previous channel and the consumer's or user's favourite channel. The first embodiment 200 according to FIG. 1 and the second embodiment 200′ according to FIG. 2 can be used in an intermixed way without problems.

Finally, the operating method of the first embodiment 200 according to FIG. 1 as well as of the second embodiment 200′ according to FIG. 2 is explained with reference to FIGS. 3A, 3B:

When the consumer or user zaps away from the primary (or first) channel to the secondary (or second) channel (=reference numeral s in FIG. 3A), the connection to the primary (or first) channel does not break. Even if the secondary (or second) channel would not contain an interactive application, the primary (or first) channel can still be monitored.

When zapping away from the primary (or first) channel to the secondary (or second) channel, the following actions are to be taken:

[i] playing the primary data stream D1;

[ii] connecting the second content managing module 102 with the content playing module 50; in a basically different implementation of the same idea with respect to the present invention, the first interactive content can be transferred from the primary content managing module 100 to the secondary content management system 102.

if the secondary data stream D2 is on a different transport stream as the primary data stream D1 (=reference numeral d in FIG. 3A):

[ii.a] creating a secondary data path P2 (with the secondary tuner 12, the secondary demodulator 22, the secondary decryption module 32, and the secondary demultiplexer 42; cf. FIG. 2) for the secondary content management system 102; and

[iii] activating the secondary content management system 102; or

if the secondary data stream D2 is on the same transport stream as the primary data stream D1 (=reference numeral t in FIG. 3A):

[iii] activating the secondary content management system 102 (without step [ii.a]).

When the consumer or user zaps back from the secondary channel to the primary channel (=reference numeral b in FIG. 3B), the following actions are to be taken:

[iv] monitoring the primary data stream D1;

[v] connecting the primary content managing module 100 with the content playing module 50; in a basically different implementation of the same idea with respect to the present invention, step [v] can also be realized as transferring content from the secondary content management system 102 to the main (or primary) content management system 100;

[vi] stopping the secondary content management system 102; and

[vi.a] stopping the second data path P2 if that second data path P2 has been created.

Between step [v] and step [vi], optionally the main (or primary) data path P1 (with the primary tuner 10, the primary demodulator 20, the primary decryption module 30, and the primary demultiplexer 40; cf. FIG. 1) for the main (or primary) content management system 100 can be created/connected.

All in all, the present invention is related to the field of digital television where interactive content is sent along with the video data. When the consumer or user changes the channel while watching interactive content and changes back somewhat later, it takes some time before the former interactive content can be shown again. In order to minimize this time the system 200, 200′ according to the present invention keeps on receiving the interactivity information in the background; in particular, the present invention proposes to keep receiving the interactive content of the last channel for which the interactivity was enabled by the consumer or user.

### LIST OF REFERENCE NUMERALS

100 first content managing module or first content managing system, in particular first D[igital]S[torage]M[edia]/C[ommand]C[ontrol] carousel
102 second content managing module or second content managing system in particular second D[igital]S[torage]M[edia]/C[ommand]C[ontrol] carousel
10 first tuner unit
12 second tuner unit
20 first demodulator unit
22 second demodulator unit
30 first decryption module
32 second decryption module
40 first demultiplexing unit
42 second demultiplexing unit
50 content playing module, in particular Java V[irtual]M[achine]
110 first cache unit
112 second cache unit
200 apparatus for controlling interactive applications (first embodiment; cf FIG. 1)
200′ apparatus for controlling interactive applications (=second embodiment; cf FIG. 2)
b switching back or zapping back from the second channel to the first channel
d second data stream D2 being on a different transport stream as the first data stream D1
D1 first data stream
D2 second data stream
P1 first path for the first content managing module 100
P2 second path for the second content managing module 102
s switching or zapping from the first channel to the second channel
t second data stream D2 being on the same transport stream as the first data stream D1

1. A content managing module, in particular D[igital]S[torage]M[edia]/C[ommand]C[ontrol] carousel, for managing the respective interactive content of at least one interactive application, wherein a first data stream comprising the first interactive application with the first interactive content is received, the first data stream being transmitted on at least one first channel, characterized in that the content managing module keeps monitoring at least the first channel and keeps at least the first interactive content available and/or up to date when switching (s) from the first channel to at least one second channel on which a second data stream, in particular containing at least one second interactive application with second interactive content, is transmitted.

2. The content managing module according to claim 1, characterized in that the content managing module does not break the connection to the first channel, in particular that the content managing module keeps monitoring the first channel and keeps the first interactive content available and/or up to date, even if the second data stream does not contain any interactive application.

3. An apparatus for controlling interactive applications, comprising at least one tuner unit for receiving, at least one first data stream at least one second data stream and optionally at least one further data stream, at least one demodulator unit for demodulating the received data streams, optionally at least one decryption module for optionally decrypting the received data streams at least one demultiplexing unit for demultiplexing, the first interactive content contained in the first data stream the second interactive content contained in the second data stream and optionally the respective further interactive content contained in the further data stream, at least one content playing module in particular Java V[irtual]M[achine], for playing the first interactive content and/or the second interactive content and/or optionally the respective further interactive content, characterized by at least one content managing module according to claim 1, being connected between the demultiplexing unit and the content playing module and being connected to at least one cache unit for keeping and/or saving the first interactive content during the time of reception of the second interactive content and/or optionally the first interactive content and/or the second interactive content during the time of reception of the respective further interactive content.

4. The apparatus according to claim 3, characterized in that the content managing module is designed to monitor the respective further interactive content of at least one further channel, in particular of the consumer's or user's favourite channel, and to keep this respective further interactive content available and/or up to date and/or to play this respective further interactive content immediately even if the further channel is not activated and/or not watched.

5. The apparatus according to claim 3, characterized in that the number of channels being monitored by the content managing module varies dynamically, in particular on the basis of parameters such as the size of the respective interactive content and/or the consumers or user's zapping behaviour.

6. The apparatus according to claim 3, characterized by the provision of at least one integrated circuit being part of at least one digital T[ele]V[ision] receiver.

7. A method for controlling interactive applications, wherein a first data stream at least one first interactive application with first interactive content is received, the first data stream being transmitted on at least one first channel, characterized by keeping receiving the first interactive content when switching (s) from the first channel to at least one second channel on which a second data stream in particular containing at least one second interactive application with second interactive content, is transmitted.

8. The method according to claim 7, characterized in that the connection to the first channel is not broken, in particular that the first channel is kept monitoring and the first interactive content is kept available and/or up to date, even if the second data stream does not contain any interactive application.

9. The method according to claim 7, characterized in that the respective further interactive content of at least one further channel, in particular of the consumer's or user's favourite channel, is received and that this respective further interactive content is kept available and/or is kept up to date and/or is played immediately even if the further channel is not activated and/or not watched.

10. The method according to claim 7, characterized in that the number of channels being monitored varies dynamically, in particular on the basis of parameters such as the size of the respective interactive content and/or the consumer's or user's zapping behaviour.

11. The method according to claim 7, characterized by the following steps:[i] playing the first data stream [s] when switching from the first channel to at least one second channel: [ii] connecting at least one second content managing module with at least one content playing module [ii.a] optionally creating at least one second path for the second content managing module [d] if the second data stream is on a different transport stream as the first data stream and [iii] activating the second content managing module.

12. The method according to claim 7, characterized in that the first interactive content is available and/or up to date and/or played immediately when switching back from the second channel to the first channel.

13. The method according to claim 7, characterized by the following steps: [iv] monitoring the first data stream; [b] when switching back from the second channel to the first channel: [v] connecting at least one first content managing module with the content playing module [vi] stopping the second content managing module and [vi.a] optionally stopping the second path in case said second path has been created in step [ii.a].

14. The method according to claim 7, characterized in that the first data stream and the second data stream are included in at least one broadcast signal.

15. The method according to claim 7, being executed by at least one computer program, being executed by at least one digital television receiver.

16. Use of at least one content managing module according to claim 1 and/or of at least one apparatus a multimedia presentation standard, such as D[igital]V[ideo]B[roadcasting], M[ultimedia]H[ome]P[latform], M[ultimedia and]H[ypermedia]E[xperts]G[roup] and/or O[pen]C[able]A[pplication] P[latform], in particular for immediately starting displaying the interactive application for the last interactively watched channel.
